(19) United States
(12) Patent Application Publication
(10) Pub. No.: US 2026/0001527 A1
(43) Pub. Date: Jan. 1, 2026

(54) CONTROL DEVICE, CONTROL METHOD, AND STORAGE MEDIUM

(71) Applicant: HONDA MOTOR CO., LTD., Tokyo (JP)

(72) Inventor: Shun IWASAKI, Tokyo (JP)

(73) Assignee: HONDA MOTOR CO., LTD., Tokyo (JP)

(21) Appl. No.: 19/230,130

(22) Filed: Jun. 6, 2025

(30) Foreign Application Priority Data
Jun. 28, 2024 (JP) 2024-104983

(51) Int. Cl. B60W 30/06; B60W 50/14

(52) U.S. Cl. CPC B60W 30/06; B60W 50/14; B60W 2520/10; B60W 2556/40

(57) ABSTRACT

A control device of a moving object that moves autonomously from a parking start position to a parking position includes: a first configured to acquire external environment information regarding a surrounding situation of the moving object; a storage configured to store route information regarding a travel route of the moving object moving from the parking start position to a predetermined parking position; and a second circuit configured to perform travel control of the moving object to a parking section set as a target parking position based on the external environment information and the route information. When the second circuit detects, from the external environment information obtained while performing the travel control, an available parking section that is available for parking the moving object and is adjacent to the travel route to the target parking position, the second circuit resets the target parking position to the available parking section.

### CROSS-REFERENCE TO RELATED APPLICATIONS

This application is based on and claims priority under 35 USC 119 from Japanese Patent Application No. 2024-104983 filed on Jun. 28, 2024, the contents of which are incorporated herein by reference.

### TECHNICAL FIELD

The present disclosure relates to a control device, a control method, and a storage medium.

### BACKGROUND

In recent years, efforts have been made to provide access to a sustainable transportation system in consideration of people vulnerable among traffic participants. In order to implement the above, focus has been placed on research and development on further improving safety and convenience of traffic by research and development related to self-driving techniques.

There is known a remote parking system that remotely operates a vehicle using a smartphone or allows the vehicle to move autonomously, to park the vehicle in a specified predetermined parking space or to cause the vehicle to exit from a parking space.

For example, Japanese Patent Application Laid-Open Publication No. 2022-184506 (hereinafter, referred to as Patent Literature 1) describes a parking assistance device that recognizes landmark information indicating a feature of an area where the vehicle is to be parked based on sensing information from surrounding monitoring sensors, and stores route information in a form of a surrounding map such as a home map including not only a parking route of automated parking but also the landmark information during the automated parking, and uses the route information including the landmarks when estimating a host vehicle position.

In remote parking in the related art, even when an object of a vehicle is to autonomously travel to park in a specified parking section, the object cannot be achieved if another vehicle is parked in the parking section.

If information on availability of each parking section can be utilized, an available parking section can be specified, but in parking lots of large commercial facilities or the like, vehicles enter and exit the parking lots frequently, and therefore, there is no guarantee that the specified parking section will still be available when the vehicle arrives.

When a user of the vehicle specifies a parking section for the vehicle, it is desirable for the user to be able to specify a parking section that is close to an entrance from the parking lot to the facility.

However, if there are no available parking sections close to the entrance, the user has to specify an available parking section further away. As mentioned above, the parking situation changes from moment to moment. The parking section close to the entrance may become available immediately after the parking section further away is specified. If the user wishes to park the vehicle in this available parking section, the user needs to perform an operation to specify the parking section. Such operations may be cumbersome for the user.

The present disclosure relates to providing a control device, a control method, and a storage medium storing a control program that enable flexible parking of a moving object to a parking section. This contributes to development of a sustainable transportation system.

### SUMMARY

A first aspect of the present disclosure relates to a control device of a moving object that moves autonomously from a parking start position to a parking position. The control device includes: an external environment recognition circuit configured to acquire external environment information regarding a surrounding situation of the moving object; a storage configured to store route information regarding a travel route of the moving object moving from the parking start position to a predetermined parking position; and a control circuit configured to perform travel control of the moving object to a parking section set as a target parking position based on the external environment information and the route information. When the control circuit detects, from the external environment information obtained while performing the travel control, an available parking section that is available for parking the moving object and is adjacent to the travel route to the target parking position, the control circuit resets the target parking position to the available parking section.

A second aspect of the present disclosure relates to a control method of a control device of a moving object that moves autonomously from a parking start position to a parking position. The moving object includes an external environment recognition circuit configured to acquire external environment information regarding a surrounding situation of the moving object, a storage configured to store route information regarding a travel route of the moving object moving from the parking start position to a predetermined parking position, and a control circuit configured to perform travel control of the moving object to a parking section set as a target parking position based on the external environment information and the route information, and the control method comprises resetting the target parking position to an available parking section, when the control circuit detects, from the external environment information obtained while performing the travel control, the available parking section that is available for parking the moving object and is adjacent to the travel route to the target parking position.

A third aspect of the present disclosure relates to a non-transitory computer-readable storage medium storing a control program of a control device of a moving object that moves autonomously from a parking start position to a parking position. The moving object includes an external environment recognition circuit configured to acquire external environment information regarding a surrounding situation of the moving object, a storage configured to store route information regarding a travel route of the moving object moving from the parking start position to a predetermined parking position, and a control circuit configured to perform travel control of the moving object to a parking section set as a target parking position based on the external environment information and the route information, and the control program causes the control circuit to reset the target parking position to an available parking section, when the control circuit detects, from the external environment information obtained while performing the travel control, the available parking section that is available for parking the moving object and is adjacent to the travel route to the target parking position.

### BRIEF DESCRIPTION OF DRAWINGS

Exemplary embodiments of the present disclosure will be described in detail based on the following figures, wherein

FIG. 1 is a side view of an example of a vehicle 10 equipped with a control device of the present disclosure;

FIG. 2 is a top view of the vehicle 10 illustrated in FIG. 1;

FIG. 3 is a block diagram illustrating an example of an internal configuration of the vehicle 10 illustrated in FIG. 1;

FIG. 4 is a diagram illustrating an example of a hardware configuration of an information terminal 60 owned by a user of the vehicle 10;

FIG. 5 is a flowchart illustrating travel control by a control ECU 20 when the vehicle 10 travels from a parking start position to a target parking position;

FIG. 6 is a diagram illustrating an example of parking the vehicle from the parking start position to a parking section set as the target parking position;

FIG. 7 is a diagram illustrating an example of parking the vehicle by resetting an available parking section as the target parking position, midway through a travel route from the parking start position to the original target parking position;

FIG. 8 is a diagram illustrating another example of parking the vehicle by resetting an available parking section as the target parking position, midway through a travel route from the parking start position to the original target parking position; and

FIG. 9 is a diagram illustrating another example of parking the vehicle by resetting an available parking section as the target parking position, midway through a travel route from the parking start position to the original target parking position.

### DESCRIPTION OF EMBODIMENTS

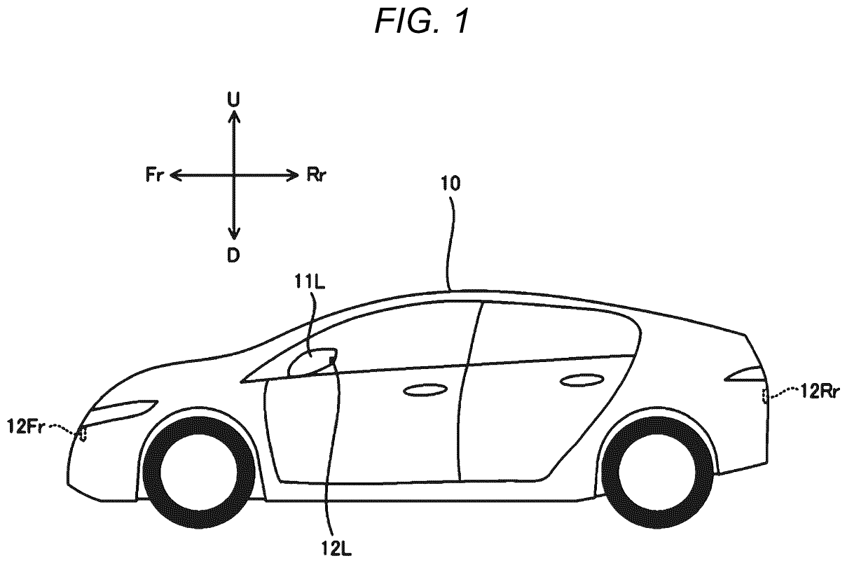

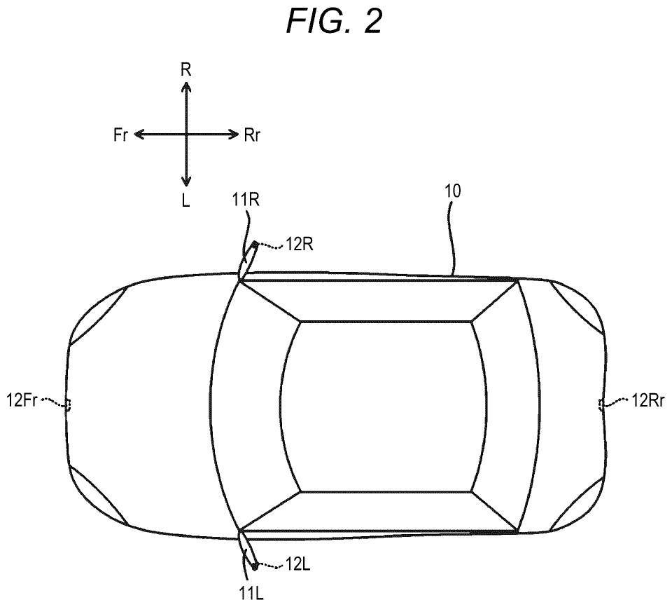

Hereinafter, an embodiment of a control device, a control method, and a control program of the present disclosure will be described with reference to the accompanying drawings. The drawings are viewed in directions of reference numerals. In order to simplify and clarify the description in the present specification or the like, a front-rear direction, a left-right direction, and an upper-lower direction are described according to directions viewed from a driver of a vehicle 10 shown in FIGS. 1 and 2. In the drawings, a front side of the vehicle 10 is shown as Fr, a rear side is shown as Rr, a left side is shown as L, a right side is shown as R, an upper side is shown as U, and a lower side is shown as D.

Vehicle 10 Equipped with Control Device of Present Disclosure

FIG. 1 is a side view of an example of a vehicle 10 equipped with a control device of the present disclosure. FIG. 2 is a top view of the vehicle 10 illustrated in FIG. 1. The vehicle 10 is an example of a “moving object” in the present disclosure.

The vehicle 10 is an automobile including a drive source (not illustrated) and wheels including drive wheels driven by power of the drive source and steerable steered wheels. In the present embodiment, the vehicle 10 is a four-wheeled automobile having a pair of left and right front wheels and a pair of left and right rear wheels. The drive source of the vehicle 10 is, for example, an electric motor. The drive source of the vehicle 10 may be an internal combustion engine such as a gasoline engine or a diesel engine, or a combination of an electric motor and an internal combustion engine. The drive source of the vehicle 10 may drive the pair of left and right front wheels, the pair of left and right rear wheels, or four wheels including the pair of left and right front wheels and the pair of left and right rear wheels. The front wheels and the rear wheels may all be steered wheels, or the front wheels or the rear wheels may be steered wheels.

The vehicle 10 further includes side mirrors 11L and 11R. The side mirrors 11L and 11R are mirrors (back mirrors) provided on outer sides of front seat doors of the vehicle 10 for the driver to check the rear side and rear lateral sides. The side mirrors 11L and 11R are fixed to a body of the vehicle 10 by rotation shafts extending in a vertical direction, and may be opened and closed by rotating about the rotation shafts.

The vehicle 10 further includes a front camera 12Fr, a rear camera 12Rr, a left side camera 12L, and a right side camera 12R. The front camera 12Fr is an imaging device (for example, a digital camera) that is provided on the front side of the vehicle 10 and captures an image in a forward direction of the vehicle 10. The rear camera 12Rr is a digital camera that is provided on the rear side of the vehicle 10 and captures an image in a rearward direction of the vehicle 10. The left side camera 12L is a digital camera that is provided on the left side mirror 11L of the vehicle 10 and captures an image in a leftward direction of the vehicle 10. The right side camera 12R is a digital camera that is provided on the right side mirror 11R of the vehicle 10 and captures an image in a rightward direction of the vehicle 10.

### Internal Configuration of Vehicle 10

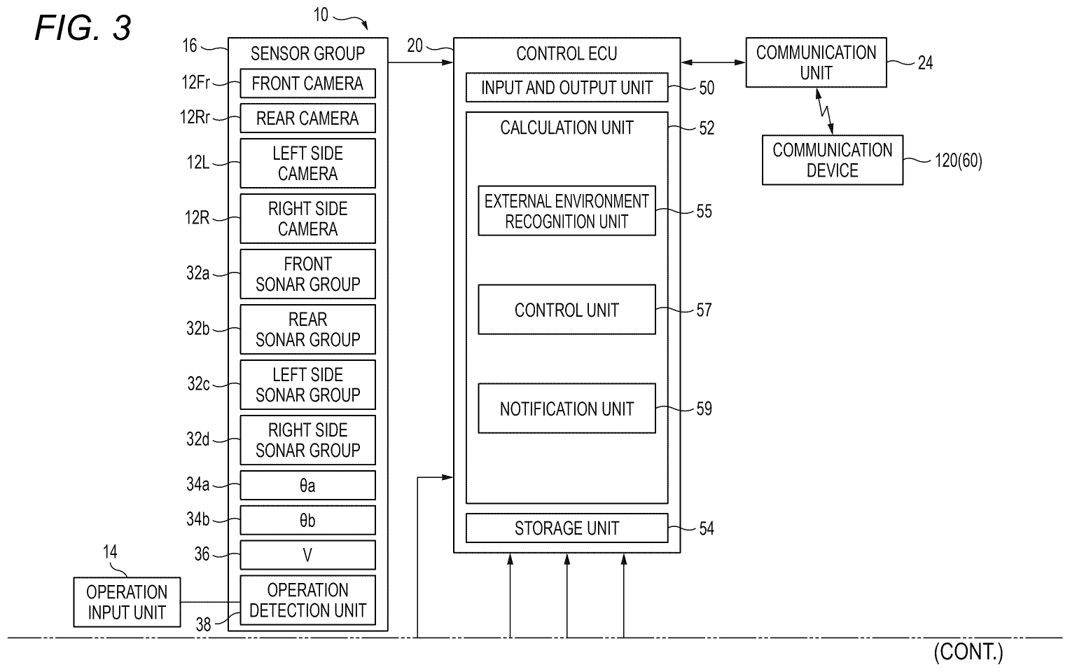

FIG. 3 is a block diagram illustrating an example of an internal configuration of the vehicle 10 illustrated in FIG. 1. As illustrated in FIG. 3, the vehicle 10 includes a sensor group 16, a navigation device 18, a control electronic control unit (control ECU) 20, an electric power steering (EPS) system 22, and a communication unit 24. The vehicle 10 further includes a driving force control system 26 and a braking force control system 28.

The sensor group 16 acquires various detection values used for control by the control ECU 20. The sensor group 16 includes the front camera 12Fr, the rear camera 12Rr, the left side camera 12L, and the right side camera 12R. The sensor group 16 also includes a front sonar group 32a, a rear sonar group 32b, a left side sonar group 32c, and a right side sonar group 32d. The sensor group 16 includes wheel sensors 34a and 34b, a vehicle speed sensor 36, and an operation detection unit 38.

The front camera 12Fr, the rear camera 12Rr, the left side camera 12L, and the right side camera 12R acquire external environment information (for example, peripheral images) regarding a surrounding situation of the vehicle 10 by capturing images of a periphery of the vehicle 10. The peripheral images of the vehicle 10 captured by the front camera 12Fr, the rear camera 12Rr, the left side camera 12L, and the right side camera 12R are referred to as a front image, a rear image, a left side image, and a right side image, respectively. An image constituted by the left side image and the right side image may be referred to as a side image. An image of the vehicle 10 and the periphery of the vehicle, which is generated by combining captured images from the front camera 12Fr, the rear camera 12Rr, the left side camera 12L, and the right side camera 12R, is referred to as a top view image of the vehicle 10.

The front sonar group 32a, the rear sonar group 32b, the left side sonar group 32c, and the right side sonar group 32d emit sound waves to the periphery of the vehicle 10, and receive reflected sounds from other objects. The front sonar group 32a includes, for example, four sonars. The sonars that constitute the front sonar group 32a are respectively provided on an obliquely left front side, a front left side, a front right side, and an obliquely right front side of the vehicle 10. The rear sonar group 32b includes, for example, four sonars. The sonars that constitute the rear sonar group 32b are respectively provided on an obliquely left rear side, a rear left side, a rear right side, and an obliquely right rear side of the vehicle 10. The left side sonar group 32c includes, for example, two sonars. The sonars that constitute the left side sonar group 32c are provided at a left side front portion and a left side rear portion of the vehicle 10, respectively. The right side sonar group 32d includes, for example, two sonars. The sonars that constitute the right side sonar group 32d are provided at a right side front portion and a right side rear portion of the vehicle 10, respectively.

The wheel sensors 34a and 34b detect rotation angles of the wheels of the vehicle 10. The wheel sensors 34a and 34b may be implemented by angle sensors or displacement sensors. The wheel sensors 34a and 34b output detection pulses each time the wheels rotate by a predetermined angle. The detection pulses output from the wheel sensors 34a and 34b are used to calculate rotation angles and rotation speeds of the wheels. A movement distance of the vehicle 10 is calculated based on the rotation angles of the wheels. The wheel sensor 34a detects, for example, a rotation angle θa of the left rear wheel. The wheel sensor 34b detects, for example, a rotation angle θb of the right rear wheel.

The vehicle speed sensor 36 detects a speed of a vehicle body of the vehicle 10, that is, a vehicle speed V, and outputs the detected vehicle speed V to the control ECU 20. The vehicle speed sensor 36 detects the vehicle speed V based on, for example, rotation of a transmission countershaft.

The operation detection unit 38 detects an operation content of a user performed using an operation input unit 14, and outputs the detected operation content to the control ECU 20. The operation input unit 14 includes various user interfaces such as a side mirror switch that switches between opened and closed states of the side mirrors 11L and 11R, and a shift lever (a selector lever or a selector).

The navigation device 18 detects a current position of the vehicle 10 by using, for example, a global positioning system (GPS), and guides the user along a route to a destination. The navigation device 18 includes a storage device (not illustrated) including a map information database. The navigation device 18 also includes a touch panel 42 and a speaker 44. The touch panel 42 functions as an input device and a display device of the control ECU 20. The speaker 44 outputs various types of guidance information to the user of the vehicle 10 by voice.

The touch panel 42 is configured such that input of various commands to the control ECU 20 can be input. For example, the user may input a command related to movement assistance of the vehicle 10 via the touch panel 42. The movement assistance includes parking assistance and exiting assistance of the vehicle 10 that can move autonomously. The touch panel 42 displays various screens related to control contents of the control ECU 20. For example, the touch panel 42 displays a screen related to the movement assistance of the vehicle 10. Specifically, the touch panel 42 displays a parking assistance button for requesting parking assistance of the vehicle 10 and an exiting assistance button for requesting exiting assistance. The parking assistance buttons include a remote parking button that requests parking by automatic steering by the control ECU 20, a support parking button that requests support when parking by a user operation, and a route-guided parking start button that requests parking including movement from a parking start position to a target parking position by travel control of the control ECU 20. The exiting assistance button includes a remote exiting button for requesting exiting by the automatic steering of the control ECU 20, and a support exiting button for requesting support while exiting by an operation of the user. Note that a constituent element other than the touch panel 42, for example, an information terminal such as a smartphone or a tablet may be used as the input device or the display device.

The “parking” is synonymous with, for example, “parking”. For example, “parking” refers to a continuous stop of a moving object (vehicle 10) in a parking section, and excludes a temporary stop at traffic signals and the like. A “parking position” is a position where the moving object (vehicle 10) is stopped, that is, a position where the moving object is parked. The “parking start position” is, for example, an entrance or an exit of a facility used by a user of the moving object. A “parking section” is a space provided in a parking lot of the facility or the like for parking one moving object (vehicle 10).

The control ECU 20 includes an input and output unit 50, a calculation unit 52, and a storage unit 54. The calculation unit 52 is implemented by, for example, a central processing unit (CPU). The calculation unit 52 executes various types of control by controlling units based on a program stored in the storage unit 54. The calculation unit 52 receives and outputs signals from and to units connected to the control ECU 20 via the input and output unit 50. The control ECU 20 is an example of a “control device” in the present disclosure.

The storage unit 54 also stores information related to remote movement of the vehicle 10. The storage unit 54 stores, for example, route information regarding a travel route of the vehicle 10 moving from a parking start position to a predetermined parking position. Note that the parking start position refers to a position of the vehicle 10 when the user starts parking, and includes, for example, a position of the vehicle 10 when the user presses the parking assistance button to activate a parking assistance function, a position of the vehicle 10 when the vehicle 10 enters a predetermined parking lot area, and a position of the vehicle 10 when the vehicle 10 arrives near a destination indicated by the navigation device 18. The route information includes parking position information, travel route information, and peripheral environment information. The parking position information is position information regarding a parking position. The travel route information is information regarding the travel route from the parking start position to the parking position, and associated with the parking position information. The peripheral environment information includes external environment information in the travel route indicated by the travel route information and associated with the travel route information, and map information regarding the travel route or environment information obtained by communication with outside.

The calculation unit 52 includes an external environment recognition unit 55 that recognizes an external environment recognition image of the vehicle 10, a control unit 57 that controls the remote movement of the vehicle 10, and a notification unit 59 that notifies movement information of the vehicle 10.

The external environment recognition unit 55 acquires the external environment information regarding the surrounding situation of the vehicle 10 (for example, peripheral images) captured by the front camera 12Fr, the rear camera 12Rr, the left side camera 12L, and the right side camera 12R from the cameras.

The control unit 57 performs parking assistance and exiting assistance of the vehicle 10 through automatic steering in which a steering 110 is automatically operated under control of the control unit 57. In the parking assistance and the exiting assistance, an accelerator pedal (not illustrated), a brake pedal (not illustrated), and the operation input unit 14 are automatically operated. Note that when the control unit 57 performs the parking assistance or the exiting assistance, the vehicle 10 may be in a state where the user (driver) is in the vehicle 10, or the user gets off the vehicle 10 and is outside the vehicle (not in the vehicle).

The control unit 57 performs travel control of the vehicle 10 to the parking section set as the target parking position based on the external environment information of the vehicle 10 acquired by the cameras and the like and the route information stored in the storage unit 54. The control unit 57 may execute the travel control according to an instruction signal input via the input and output unit 50. The input instruction signal includes an instruction signal transmitted by wireless communication from an information terminal or the like that is portable by the user of the vehicle 10. The control unit 57 may transmit information regarding the travel control to the information terminal or the like via the input and output unit 50.

When the vehicle 10 is stopped at the parking start position and all passengers get off, and a parking section is set as the target parking position, the control unit 57 starts the travel control of the vehicle 10 to the parking section according to an instruction signal transmitted via wireless communication from the information terminal or the like portable by the user of the vehicle 10.

When the control unit 57 changes the target parking position while executing the travel control, the notification unit 59 transmits route information regarding the travel route to the parking section of the changed target parking position to the information terminal or the like of the user of the vehicle 10. Note that the notification unit 59 may perform the notification using, for example, the navigation device 18 of the vehicle 10. The route information notified by the notification unit 59 includes at least one of the parking position information, the travel route information, and the peripheral environment information regarding the parking section of the changed target parking position.

The EPS system 22 includes a steering angle sensor 100, a torque sensor 102, an EPS motor 104, a resolver 106, and an EPS ECU 108. The steering angle sensor 100 detects a steering angle θst of the steering 110. The torque sensor 102 detects a torque TQ applied to the steering 110.

The EPS motor 104 applies a driving force or a reaction force to a steering column 112 coupled to the steering wheel 110, thereby enabling operation assistance to the steering wheel 110 by an occupant and automatic steering during parking assistance. The resolver 106 detects a rotation angle θm of the EPS motor 104. The EPS ECU 108 controls the entire EPS system 22. The EPS ECU 108 includes an input and output unit (not illustrated), a calculation unit (not illustrated), and a storage unit (not illustrated).

The communication unit 24 enables wireless communication with another communication device 120. Another communication device 120 includes a base station, a communication device of another vehicle, an information terminal 60 such as a smartphone or a tablet that is portable for the user of the vehicle 10, and the like. For example, the communication unit 24 includes an ultra wide band (UWB, registered trademark) interface or the like that can execute UWB communication with the information terminal 60.

The driving force control system 26 includes a driving ECU 130. The driving force control system 26 executes driving force control of the vehicle 10. The driving ECU 130 controls a driving force of the vehicle 10 by controlling an engine (not illustrated) or the like based on an operation by the user on an accelerator pedal (not illustrated).

The braking force control system 28 includes a braking ECU 132. The braking force control system 28 executes braking force control of the vehicle 10. The braking ECU 132 controls a braking force of the vehicle 10 by controlling a brake mechanism or the like (not illustrated) based on an operation by the user on a brake pedal (not illustrated).

### Hardware Configuration of Information Terminal 60 of User

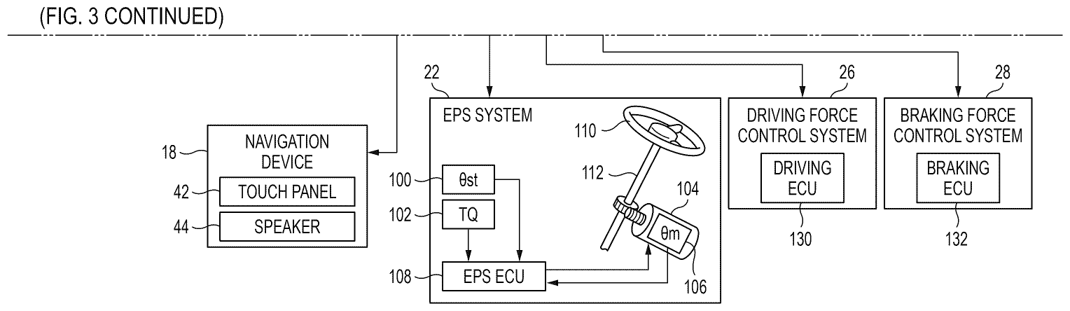

FIG. 4 is a diagram illustrating an example of a hardware configuration of an information terminal 60 owned by a user of the vehicle 10. The information terminal 60 includes a processor 61, a memory 62, a communication interface 63, and a user interface 64. The processor 61, the memory 62, the communication interface 63, and the user interface 64 are connected by, for example, a bus 65.

The processor 61 is a circuit that executes signal processing, and is, for example, a central processing unit (CPU) that controls the entire information terminal 60. Note that the processor 61 may be implemented by another digital circuit such as a field programmable gate array (FPGA) or a digital signal processor (DSP). The processor 61 may also be implemented by combining a plurality of digital circuits.

The memory 62 includes, for example, a main memory and an auxiliary memory. The main memory is, for example, a random access memory (RAM). The main memory is used as a work area of the processor 61.

The auxiliary memory is a non-volatile memory such as a magnetic disk, an optical disk, or a flash memory. The auxiliary memory stores various programs for operating the information terminal 60. The programs stored in the auxiliary memory are loaded into the main memory and executed by the processor 61.

The auxiliary memory may include a portable memory removable from the information terminal 60. Examples of the portable memory include a universal serial bus (USB) flash drive, a memory card such as a secure digital (SD) memory card, and an external hard disk drive.

The communication interface 63 is a communication interface that executes wireless communication with the outside of the information terminal 60 (for example, the communication unit 24 of the vehicle 10). For example, the communication interface 63 includes a UWB interface for executing UWB communication with the vehicle 10. The communication interface 63 is controlled by the processor 61.

The user interface 64 includes, for example, an input device that receives an operation input from the user and an output device that outputs information to the user. The input device may be implemented by, for example, a touch panel. The output device can be implemented by, for example, a display or a speaker. The user interface 64 is controlled by the processor 61.

According to a specific operation on a terminal screen of the information terminal 60, the processor 61 transmits an instruction for the control unit 57 of the vehicle 10 to start the travel control to the vehicle 10 via the communication interface 63. An application capable of managing the travel control of the vehicle 10 by transmitting and receiving information regarding the travel control to and from the vehicle 10 is installed in the information terminal 60.

### Travel Control Method of Control ECU 20

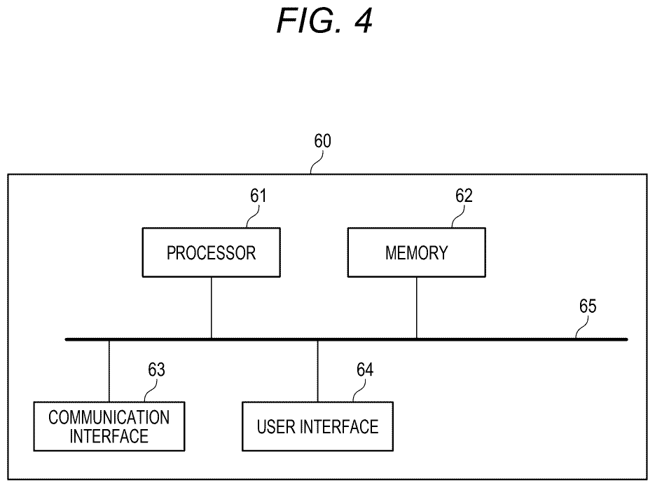

Next, the travel control of the vehicle 10 from the parking start position to the target parking position will be described with reference to FIG. 5. FIG. 5 is a flowchart illustrating the travel control by the control ECU 20 when the vehicle 10 travels from the parking start position to the target parking position.

First, the control ECU 20 determines whether the user gives a parking start instruction to the vehicle 10 at the parking start position (step S11). Note that the control ECU 20 determines that the vehicle 10 is at the parking start position when the vehicle 10 enters a predetermined parking lot area or arrives near a destination indicated by the navigation device 18. The control ECU 20 determines that the user instructs to start parking the vehicle 10 when the user presses the route-guided parking start button or when a predetermined instruction signal transmitted from the information terminal of the user or the like is received. The following description will be given on an assumption that the vehicle 10 arrives at a parking lot of a shopping mall and the user presses the route-guided parking start button.

In step S11, if the user does not instruct to start parking the vehicle 10 (step S11: No), the control ECU 20 repeats the determination of step S11. In step S11, if the user instructs to start parking the vehicle 10 (step S11: Yes), the control ECU 20 starts the travel control of the vehicle 10 from the parking start position to the target parking position (step S12). Note that when the vehicle 10 starts traveling by the travel control, it is not necessary for the user to get on the vehicle 10. In other words, even when all passengers get off the vehicle 10, the control ECU 20 can also starts executing the travel control.

The target parking position is a parking section set by the user before the instruction, or a parking section determined by the control ECU 20 based on the information stored in the storage unit 54.

While the vehicle 10 is traveling toward the target parking position, the control ECU 20 performs the travel control of the vehicle 10 to the parking section of the target parking position based on the external environment information acquired by the external environment recognition unit 55 and the route information regarding the travel route to the target parking position. The control ECU 20 determines, from the external environment information obtained while executing the travel control, whether an available parking section available for parking the vehicle 10 that is adjacent to the travel route of the vehicle 10 to the target parking position is detected (step S13). Note that the control ECU 20 excludes, from a detection target as the available parking section, the parking section selected by the user of the vehicle 10 in advance among parking sections indicated by the parking position information in the route information stored in the storage unit 54.

In step S13, if no available parking section adjacent to the travel route is detected (step S13: No), the control ECU 20 proceeds to step S15, which will be described later. On the other hand, if an available parking section adjacent to the travel route is detected (step S13: Yes), the control ECU 20 resets the target parking position to the detected available parking section (step S14). The control ECU 20 determines whether the vehicle 10 arrives at the target parking position and whether parking of the vehicle 10 in the parking section set as the target parking position is completed (step S15).

In step S15, if the parking of the vehicle 10 at the target parking position is not completed (step S15: No), the control ECU 20 proceeds to step S13 described above. On the other hand, if the parking of the vehicle 10 at the target parking position is completed (step S15: Yes), the control ECU 20 stores the route information regarding the travel route to the target parking position in the storage unit 54 (step S16).

### Travel Control by Control ECU 20

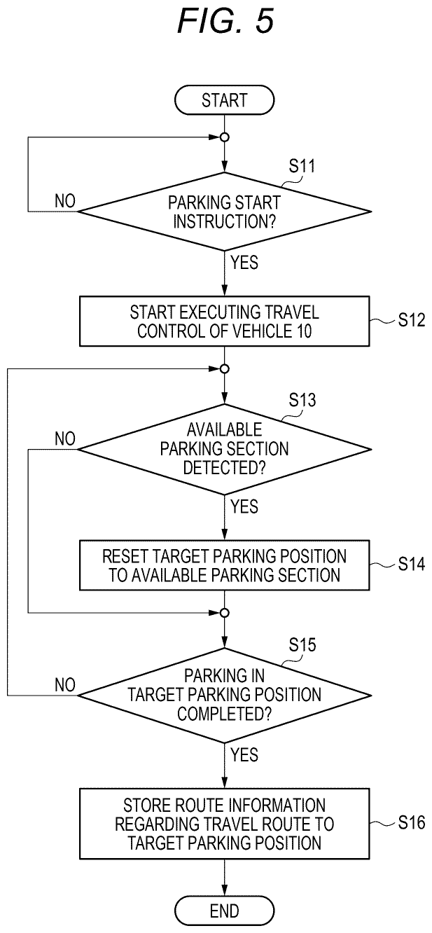

Next, the traveling of the vehicle 10 from the parking start position to the parking section set as the target parking position based on the travel control of the control ECU 20 will be described with reference to FIGS. 6 to 9. FIG. 6 is a diagram illustrating an example of parking the vehicle from the parking start position to the parking section set as the target parking position. As illustrated in FIG. 6, after a user U who drives the vehicle 10 arrives at a parking lot 70 of a shopping mall, the user U gets off the vehicle 10 and attempts to park the vehicle 10 in a parking section Ptar in the parking lot 70. In other words, the parking section Ptar is set as the target parking position.

When the user U gets off the vehicle 10 while carrying the information terminal 60 and operates the information terminal 60 to instruct the vehicle 10 to park using a route guidance function, the control ECU 20 of the vehicle 10 starts the travel control described above with reference to FIG. 5. Note that the stop position of the vehicle 10 when the above instruction is given is the parking start position. The control ECU 20 performs the travel control so that the vehicle 10 starts traveling from the parking start position, travels along a travel route Rtar illustrated in FIG. 6, reaches the parking section Ptar, and is parked in the parking section Ptar.

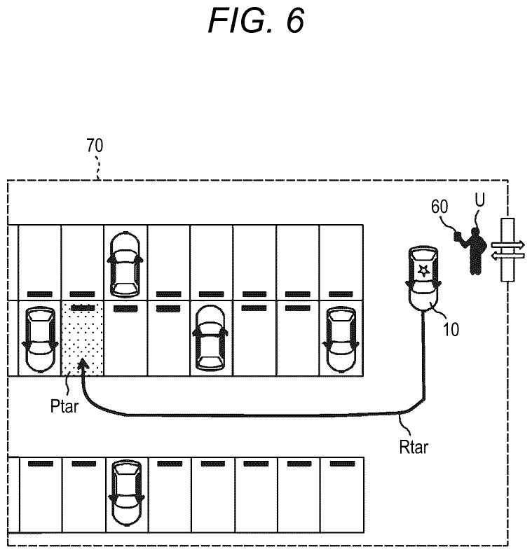

The control ECU 20 performs the travel control of the vehicle 10 based on the external environment information acquired by the external environment recognition unit 55 and the route information regarding the travel route to the parking section Ptar stored in the storage unit 54. In the present embodiment, as illustrated in FIG. 7, the control ECU 20 detects, based on the external environment information obtained while the vehicle 10 is traveling along a travel route to the parking section Ptar, an available parking section Pdet available for parking the vehicle 10 and adjacent to the travel route. The control ECU 20 determines whether it is possible to generate a movement route from a current position of the vehicle 10 to the available parking section Pdet. Note that it is necessary that in the movement route, the available parking section Pdet does not overlap other parking sections adjacent thereto.

If determining that it is possible to generate a movement route to the available parking section Pdet, the control ECU 20 resets the target parking position to the available parking section Pdet. On the other hand, if determining that it is not possible to generate a movement route to the available parking section Pdet, the control ECU 20 does not reset the target parking position to the available parking section Pdet, and continues travel control toward the parking section Ptar.

In determining whether it is possible to generate the movement route described above, if a distance D between a branch point Bdet for heading to the available parking section Pdet on the travel route Rtar to the parking section Ptar and the current position of the vehicle 10 is equal to or greater than a predetermined distance, the control ECU 20 determines that it is possible to generate a movement route to the available parking section Pdet. The predetermined distance that is compared with the distance D varies depending on a travel speed of the vehicle 10 when the determination is made. The faster the travel speed of the vehicle 10, the longer the predetermined distance.

If resetting the target parking position to the available parking section Pdet, the control ECU 20 generates route information regarding the travel route to the available parking section Pdet, and transmits at least one of the parking position information, the travel route information, and the peripheral environment information included in the route information to the information terminal 60 of the user U.

Note that if determining that it is possible to generate a movement route to the available parking section Pdet, the control ECU 20 may transmit at least one of the parking position information, the travel route information, and the peripheral environment information included in the route information regarding the travel route to the available parking section Pdet to the information terminal 60 of the user U before resetting the target parking position to the available parking section Pdet. In this case, for example, a screen of the information terminal 60 displays a parking frame having a different form from a parking frame indicating the target parking position, superimposed on the available parking section Pdet. When receiving an instruction permitting resetting of the target parking position to the available parking section Pdet, the control ECU 20 resets the target parking position to the available parking section Pdet.

The control ECU 20 controls the movement of the vehicle 10 from the time when the available parking section Pdet is detected until the time when the control ECU 20 receives the above instruction transmitted from the information terminal 60. During this period of time, the vehicle 10 may move slowly along the travel route to the parking section Ptar, or may stop traveling until the above instruction transmitted from the information terminal 60 is received. In the case of stopping traveling, the vehicle 10 may stop with a direction indicator flickering to indicate the path change on the movement route to the available parking section Pdet to surroundings, and then start traveling again after receiving the above instruction transmitted from the information terminal 60.

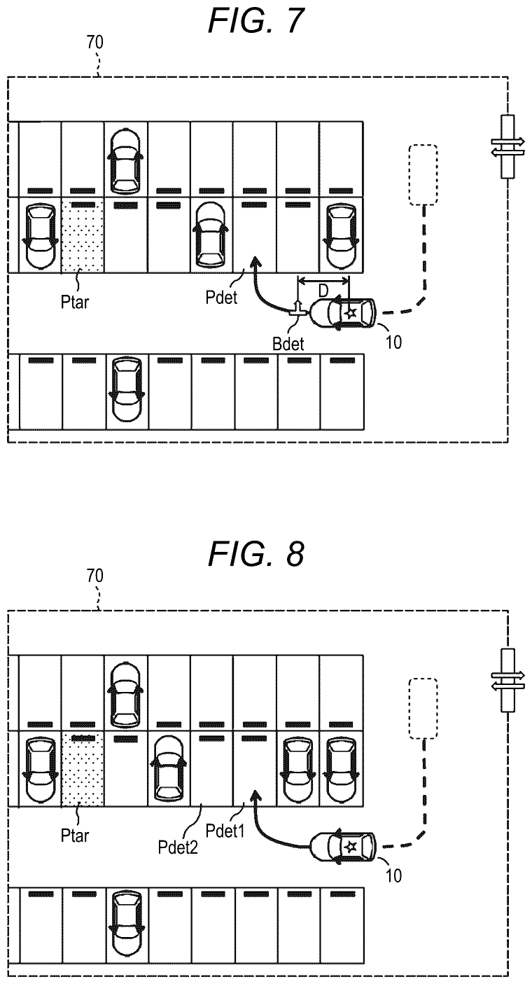

As illustrated in FIG. 8, while the vehicle 10 is traveling along the travel route to the parking section Ptar, the control ECU 20 detects a plurality of available parking sections Pdet1 and Pdet2 available for parking the vehicle 10 and adjacent to the travel route, and if it is possible to generate a movement route to any one section, the control ECU 20 selects one of the plurality of available parking sections Pdet1 and Pdet2 based on a predetermined condition. The control ECU 20 resets the target parking position to the selected available parking section. The predetermined condition includes a condition such as that a distance between each branch point heading to the available parking sections Pdet1 and Pdet2 on the travel route Rtar to the parking section Ptar and the current position of the vehicle 10 is equal to or greater than the predetermined distance and is the shortest.

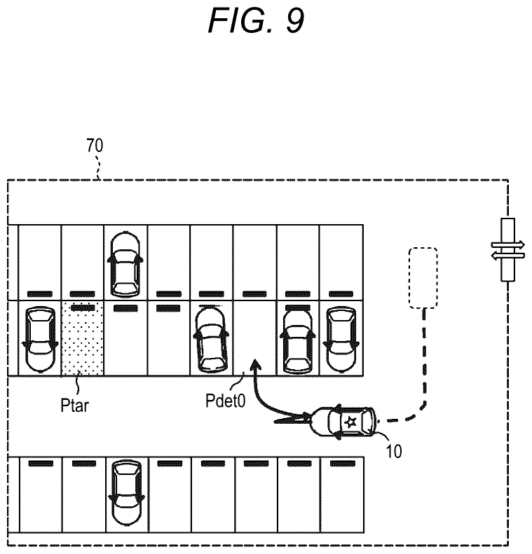

As illustrated in FIG. 9, when the control ECU 20 detects an available parking section Pdet0 while the vehicle 10 is traveling along the travel route to the parking section Ptar, but the vehicle 10 cannot enter the available parking section Pdet0 directly from the current position, the control ECU 20 may cause the vehicle 10 to retract along the travel route Rtar and then reset the target parking position to the available parking section Pdet0.

When the control ECU 20 resets the target parking position to the available parking section, and then determines from the external environment information that the vehicle 10 cannot be parked in that available parking section, the control ECU 20 returns the target parking position to the parking section Ptar before the resetting, and performs the travel control of the vehicle 10 based on the route information and the external environment information regarding the travel route to the parking section Ptar.

As described above, if the control ECU 20 of the present embodiment detects an available parking section midway through the travel route from the parking start position to the target parking position, the control ECU 20 resets the target parking position to the available parking section and then performs the travel control of the vehicle 10 to the reset target parking position. In this way, parking in a parking section can be performed flexibly depending on the availability in the parking lot. Therefore, even if another vehicle parks at the target parking position while the vehicle 10 is traveling along the travel route to the target parking position, a parking place for the vehicle 10 can be ensured. In other words, convenience for the user of the vehicle 10 can be improved. It is also possible to reduce anxiety of the user due to that a parking place for the vehicle 10 may not be ensured. It is also possible to meet a desire of the user to park the vehicle 10 in a parking section as close as possible to an entrance from the parking lot to the facility. Furthermore, the route information regarding the travel route stored in the storage unit 54, which is necessary for setting the target parking position, only needs to include the travel route to the original target parking position, and there is no need to register travel routes to available parking sections in the parking lot, thereby reducing a burden on capacity of the storage unit 54.

Although the embodiment of the present disclosure has been described above, the present disclosure is not limited to the above-described embodiment, and modifications, improvements, and the like may be appropriately made.

In the above-described embodiment, an example in which the moving object is a vehicle (four-wheeled automobile) has been described, but the moving object is not limited thereto. For example, the moving object may be a vehicle such as a two-wheeled vehicle or a Segway. Further, the idea of the present disclosure is not limited to the vehicle, and may also be applied to a robot, a ship, an aircraft, or the like that includes a drive source and is movable by power of the drive source.

In the present specification, at least the following matters are described. Although corresponding constituent elements or the like in the embodiment described above are shown in parentheses, the present disclosure is not limited thereto.
(1) A control device (control ECU 20) of a moving object (vehicle 10) that moves autonomously from a parking start position to a parking position, the control device including:
an external environment recognition circuit (external environment recognition unit 55) configured to acquire external environment information regarding a surrounding situation of the moving object;
a storage (storage unit 54) configured to store route information regarding a travel route of the moving object moving from the parking start position to a predetermined parking position; and
a control circuit (control unit 57) configured to perform travel control of the moving object to a parking section set as a target parking position based on the external environment information and the route information, in which
when the control circuit detects, from the external environment information obtained while executing the travel control, an available parking section that is available for parking the moving object and is adjacent to the travel route to the target parking position, the control circuit resets the target parking position to the available parking section.

According to (1), if an available parking section is detected midway through the travel route from the parking start position to the target parking position, the target parking position is reset to the available parking section and then the travel control of the moving object to the reset target parking position is performed. In this way, parking in a parking section can be performed flexibly depending on the availability in the parking lot. In other words, convenience for the user of the moving object can be improved. It is also possible to reduce anxiety of the user due to that a parking place for the moving object may not be ensured. It is also possible to meet a desire of the user to park the moving object in a parking section as close as possible to an entrance from the parking lot to the facility. Furthermore, the route information regarding the travel route stored in the storage, which is necessary for setting the target parking position, only needs to include the travel route to the original target parking position, and there is no need to register travel routes to available parking sections, thereby reducing a burden on capacity of the storage.
(2) The control device according to (1), in which
the route information regarding the travel route to the parking position includes parking position information, travel route information, and peripheral environment information,
the parking position information is position information regarding the parking position,
the travel route information is information regarding the travel route from the parking start position to the parking position and associated with the parking position information, and
the peripheral environment information includes the external environment information acquired by the external environment recognition circuit in the travel route indicated by the travel route information and associated with the travel route information, and map information related to the travel route or environment information obtained by communication with outside.

According to (2), since the route information includes the parking position information, the travel route information, and the peripheral environment information, travel control can be performed based on an accurate situation of the moving object.
(3) The control device according to (1) or (2), in which
after detecting the available parking section, the control circuit determines whether it is possible to generate a movement route from a current position of the moving object to the available parking section,
if it is possible to generate the movement route, the control circuit resets the target parking position to the available parking section and generates the movement route, and
if it is not possible to generate the movement route, the control circuit does not reset the target parking position to the available parking section.

According to (3), the target parking position can be reset to the available parking section only when a movement route from the current position to the available parking section can be generated.
(4) The control device according to (3), in which
when determining whether it is possible to generate the movement route, the control circuit determines that it is possible to generate the movement route if a distance between a branch point for heading to the available parking section on the travel route to the target parking position and the current position of the moving object is equal to or greater than a predetermined distance.

According to (4), the movement route can be generated and the moving object can be parked in the available parking section only when the moving object can move toward the available parking section without retracting.
(5) The control device according to (4), in which
the predetermined distance varies depending on a travel speed of the moving object when the control circuit determines whether it is possible to generate the movement route.

According to (5), it is possible to accurately determine whether the moving object can move toward the available parking section without retracting.
(6) The control device according to (2), in which
when resetting the target parking position to the available parking section, the control circuit notifies a user of the moving object of at least one of the parking position information, the travel route information, and the peripheral environment information included in the route information regarding the travel route to the available parking section.

According to (6), the user can be notified that the target parking position is reset to the available parking section.
(7) The control device according to (2), in which
when the available parking section is detected during the travel control, the control circuit notifies a user of the moving object of at least one of the parking position information, the travel route information, and the peripheral environment information included in the route information regarding the travel route to the available parking section, and receives an instruction sent from the user indicating whether to reset the target parking position to the available parking section.

According to (7), the target parking position can be reset to the available parking section after confirmation by the user.
(8) The control device according to (1), in which
when a plurality of the available parking sections are detected during the travel control, the control circuit selects one of the plurality of available parking sections based on a predetermined condition.

According to (8), even when a plurality of available parking sections are detected, one available parking section can be selected.
(9) The control device according to (1), in which
when determining that it is not possible for the moving object to park in the available parking section after resetting the target parking position to the available parking section, the control circuit returns the target parking position to the parking section before the resetting, and performs the travel control based on the route information and the external environment information regarding the travel route to the parking section before the resetting.

According to (9), if the moving object cannot be parked in the available parking section that is reset as the target parking position, the target parking position can be returned to the parking section before the resetting, so that the travel control can be continued.
(10) The control device according to (1), in which
when the target parking position is reset to the available parking section and parking of the moving object in the available parking section is completed, the control circuit registers in the storage the route information regarding the travel route from the parking start position to the available parking section.

According to (10), the number of options as a target parking position can be increased the next time the moving object is parked.
(11) The control device according to (1), in which
the control circuit causes an information terminal carried by a user of the moving object to display a parking frame having a different form from a parking frame indicating the target parking position, superimposed on the available parking section.

According to (11), the user can clearly distinguish between the parking section set as the target parking position and the available parking section.
(12) The control device according to (3), in which
the control circuit generates the movement route from the current position of the moving object to the available parking section where no other parking sections overlap.

According to (12), parking can be reliably performed in the available parking section.
(13) The control device according to (2), in which
the control circuit excludes, from a detection target as the available parking section, a parking section selected by a user of the moving object among parking sections indicated by the parking position information in the route information stored in the storage.

According to (13), the moving object can be parked in a parking section according to an intention of the user.
(14) A control method of a control device of a moving object that moves autonomously from a parking start position to a parking position, in which
the moving object includes
   an external environment recognition circuit that acquires external environment information regarding a surrounding situation of the moving object,
   a storage that stores route information regarding a travel route of the moving object moving from the parking start position to a predetermined parking position, and
   a control circuit that performs travel control of the moving object to a parking section set as a target parking position based on the external environment information and the route information, and
the control method comprises resetting the target parking position to an available parking section, when the control circuit detects, from the external environment information obtained while performing the travel control, the available parking section that is available for parking the moving object and is adjacent to the travel route to the target parking position.

According to (14), if an available parking section is detected midway through the travel route from the parking start position to the target parking position, the target parking position is reset to the available parking section and then the travel control of the moving object to the reset target parking position is performed. In this way, parking in a parking section can be performed flexibly depending on the availability in the parking lot. In other words, convenience for the user of the moving object can be improved. It is also possible to reduce anxiety of the user due to that a parking place for the moving object may not be ensured. It is also possible to meet a desire of the user to park the moving object in a parking section as close as possible to an entrance from the parking lot to the facility. Furthermore, the route information regarding the travel route stored in the storage, which is necessary for setting the target parking position, only needs to include the travel route to the original target parking position, and there is no need to register travel routes to available parking sections, thereby reducing a burden on capacity of the storage.
(15) A non-transitory computer-readable storage medium storing a control program of a control device of a moving object that moves autonomously from a parking start position to a parking position, wherein
the moving object includes
   an external environment recognition circuit configured to acquire external environment information regarding a surrounding situation of the moving object,
   a storage configured to store route information regarding a travel route of the moving object moving from the parking start position to a predetermined parking position, and
   a control circuit configured to perform travel control of the moving object to a parking section set as a target parking position based on the external environment information and the route information, and
the control program causes the control circuit to reset the target parking position to an available parking section, when the control circuit detects, from the external environment information obtained while performing the travel control, the available parking section that is available for parking the moving object and is adjacent to the travel route to the target parking position.

According to (15), if an available parking section is detected midway through the travel route from the parking start position to the target parking position, the target parking position is reset to the available parking section and then the travel control of the moving object to the reset target parking position is performed. In this way, parking in a parking section can be performed flexibly depending on the availability in the parking lot. In other words, convenience for the user of the moving object can be improved. It is also possible to reduce anxiety of the user due to that a parking place for the moving object may not be ensured. It is also possible to meet a desire of the user to park the moving object in a parking section as close as possible to an entrance from the parking lot to the facility. Furthermore, the route information regarding the travel route stored in the storage, which is necessary for setting the target parking position, only needs to include the travel route to the original target parking position, and there is no need to register travel routes to available parking sections, thereby reducing a burden on capacity of the storage.

1. A control device of a moving object that moves autonomously from a parking start position to a parking position, the control device comprising:
an external environment recognition circuit configured to acquire external environment information regarding a surrounding situation of the moving object;
a storage configured to store route information regarding a travel route of the moving object moving from the parking start position to a predetermined parking position; and
a control circuit configured to perform travel control of the moving object to a parking section set as a target parking position based on the external environment information and the route information, wherein
when the control circuit detects, from the external environment information obtained while performing the travel control, an available parking section that is available for parking the moving object and is adjacent to the travel route to the target parking position, the control circuit resets the target parking position to the available parking section.

2. The control device according to claim 1, wherein
the route information regarding the travel route to the parking position includes parking position information, travel route information, and peripheral environment information,
the parking position information is position information regarding the parking position,
the travel route information is information regarding the travel route from the parking start position to the parking position and associated with the parking position information, and
the peripheral environment information includes the external environment information acquired by the external environment recognition circuit in the travel route indicated by the travel route information and associated with the travel route information, and map information related to the travel route or environment information obtained by communication with outside.

3. The control device according to claim 1, wherein
after detecting the available parking section, the control circuit determines whether it is possible to generate a movement route from a current position of the moving object to the available parking section,
if it is possible to generate the movement route, the control circuit resets the target parking position to the available parking section and generates the movement route, and
if it is not possible to generate the movement route, the control circuit does not reset the target parking position to the available parking section.

4. The control device according to claim 3, wherein
when determining whether it is possible to generate the movement route, the control circuit determines that it is possible to generate the movement route if a distance between a branch point for heading to the available parking section on the travel route to the target parking position and the current position of the moving object is equal to or greater than a predetermined distance.

5. The control device according to claim 4, wherein
the predetermined distance varies depending on a travel speed of the moving object when the control circuit determines whether it is possible to generate the movement route.

6. The control device according to claim 2, wherein
when resetting the target parking position to the available parking section, the control unit notifies a user of the moving object of at least one of the parking position information, the travel route information, and the peripheral environment information included in the route information regarding the travel route to the available parking section.

7. The control device according to claim 2, wherein
when the available parking section is detected during the travel control, the control circuit notifies a user of the moving object of at least one of the parking position information, the travel route information, and the peripheral environment information included in the route information regarding the travel route to the available parking section, and receives an instruction sent from the user indicating whether to reset the target parking position to the available parking section.

8. The control device according to claim 1, wherein
when a plurality of the available parking sections are detected during the travel control, the control circuit selects one of the plurality of available parking sections based on a predetermined condition.

9. The control device according to claim 1, wherein
when determining that it is not possible for the moving object to park in the available parking section after resetting the target parking position to the available parking section, the control circuit returns the target parking position to the parking section before the resetting, and performs the travel control based on the route information and the external environment information regarding the travel route to the parking section before the resetting.

10. The control device according to claim 1, wherein
when the target parking position is reset to the available parking section and parking of the moving object in the available parking section is completed, the control circuit registers in the storage the route information regarding the travel route from the parking start position to the available parking section.

11. The control device according to claim 1, wherein
the control circuit causes an information terminal carried by a user of the moving object to display a parking frame having a different form from a parking frame indicating the target parking position, superimposed on the available parking section.

12. The control device according to claim 3, wherein
the control circuit generates the movement route from the current position of the moving object to the available parking section where no other parking sections overlap.

13. The control device according to claim 2, wherein
the control circuit excludes, from a detection target as the available parking section, a parking section selected by a user of the moving object among parking sections indicated by the parking position information in the route information stored in the storage.

14. A control method of a control device of a moving object that moves autonomously from a parking start position to a parking position, wherein
the moving object includes
an external environment recognition circuit configured to acquire external environment information regarding a surrounding situation of the moving object,
a storage configured to store route information regarding a travel route of the moving object moving from the parking start position to a predetermined parking position, and
a control circuit configured to perform travel control of the moving object to a parking section set as a target parking position based on the external environment information and the route information, and
the control method comprises resetting the target parking position to an available parking section, when the control circuit detects, from the external environment information obtained while performing the travel control, the available parking section that is available for parking the moving object and is adjacent to the travel route to the target parking position.

15. A non-transitory computer-readable storage medium storing a control program of a control device of a moving object that moves autonomously from a parking start position to a parking position, wherein
the moving object includes
an external environment recognition circuit configured to acquire external environment information regarding a surrounding situation of the moving object,
a storage configured to store route information regarding a travel route of the moving object moving from the parking start position to a predetermined parking position, and
a control circuit configured to perform travel control of the moving object to a parking section set as a target parking position based on the external environment information and the route information, and
the control program causes the control circuit to reset the target parking position to an available parking section, when the control circuit detects, from the external environment information obtained while performing the travel control, the available parking section that is available for parking the moving object and is adjacent to the travel route to the target parking position.
